(19) United States
(12) Patent Application Publication
(10) Pub. No.: US 2016/0078835 A1
(43) Pub. Date: Mar. 17, 2016

(54) DISPLAY DRIVING CIRCUIT AND DISPLAY DEVICE

(71) Applicant: SILICON WORKS, CO., LTD., Daejeon (KR)

(72) Inventors: Hyun Ho CHO, Incheon-si (KR); Joon Ho NA, Daejeon-si (KR); Hyun Kyu JEON, Daejeon-si (KR); Yong Ik JUNG, Bucheon-si (KR)

(21) Appl. No.: 14/787,088

(22) PCT Filed: Apr. 22, 2014
(86) PCT No.: PCT/KR2014/003479

§ 371 Date: Oct. 26, 2015

(30) Foreign Application Priority Data
Apr. 25, 2013 (KR) 10-2013-0046307

(51) Int. Cl. G09G 3/36

(52) U.S. Cl. CPC G09G 3/3685; G09G 3/3696; G09G 3/3614; G09G 2310/0291; G09G 2330/023; G09G 2320/041

(57) ABSTRACT

A display driving circuit may include: an output buffer unit including a plurality of output buffer pairs, wherein among the plurality of output buffer pairs, each of first output buffers has a first voltage driving potential, and each of second output buffers has a second voltage driving potential; an output switch unit configured to directly connect the plurality of output buffer pairs to a plurality of output line pairs or cross and connect the plurality of output buffer pairs to the plurality of output line pairs; and a charge sharing switch unit configured to connect first output lines corresponding to the first output buffers, and connect second output lines corresponding to the second output buffers. Through this configuration, the display driving circuit can reduce power consumption and heat generation.

### BACKGROUND

1. Technical Field

The present disclosure relates to a display driving technology, and more particularly, to a display driving circuit capable of reducing power consumption and heat generation.

2. Related Art

A display driving circuit is operated according to an AC direct driving method, in order to reduce image sticking which may occur as a polar material existing in a display adheres to an electrode. Furthermore, the display driving circuit uses an inversion driving method, in order to control flicker which appears due to parasitic capacitance of TFTs (Thin Film Transistors) arranged in a display panel.

The conventional display driving circuit selectively supplies buffered pixel driving signals to output lines according to the inversion driving method. Furthermore, while no data signals are applied to the display in order to reduce power consumption required for buffering the pixel driving signals, the conventional display driving circuit may connect the output lines to each other so as to pre-drive an output voltage to an intermediate potential Vcom.

FIG. 1 is a waveform diagram illustrating outputs of the conventional display driving circuit.

Referring to FIG. 1, the conventional display driving circuit provides an output voltage Vout to the display, the output voltage Vout varying with time. The conventional display driving circuit may supply valid data at a panel charge/discharge period t1, and pre-drive the output voltage to the intermediate potential Vcom through connection or charge sharing between the output lines at a charge sharing period t2.

The panel charge/discharge period t1 corresponds to a time range in which valid data are supplied to the display panel, and the charge sharing period t2 corresponds to a part of a period in which the valid data are loaded before the valid data are supplied, and a time range which is arbitrarily set for the output lines to share electrical charges. Furthermore, the valid data correspond to image data which are applied to the display panel and actually displayed.

The conventional display driving circuit uses an intermediate potential Vcom between a first polarity (+) and a second polarity (−) in order to provide the output voltage Vout. The conventional display driving circuit provides the output voltage Vout changed to the first polarity (+) from the intermediate potential Vcom, or provides the output voltage Vout changed to the second polarity (−) from the intermediate potential Vcom. Through this operation, the conventional driving circuit can reduce power consumption, compared to the technology which changes the output voltage Vout from the first polarity (+) to the second polarity (−).

However, the conventional display driving circuit pre-drives the output voltage Vout from the first polarity (+) to the intermediate potential Vcom or pre-drives the output voltage Vout from the second polarity (−) to the intermediate potential Vcom at the charge sharing period t2, even though inversion is not necessary. Thus, the power consumption of the conventional display driving circuit is increased by unnecessary pre-driving.

### SUMMARY

Various embodiments are directed to a display driving circuit capable of minimizing power consumption and heat generation.

Also, various embodiments are directed to a display driving circuit capable of efficiently performing charge sharing for an output voltage.

Also, various embodiments are directed to a display driving circuit capable of reducing current consumption and heat generation when the polarity of an output voltage provided to a display is inverted.

Among embodiments, a display device may include a display panel and a display driving circuit for driving the display panel.

In an embodiment, a display driving circuit may include: an output buffer unit including a plurality of output buffer pairs, wherein among the plurality of output buffer pairs, each of first output buffers has a first voltage driving potential, and each of second output buffers has a second voltage driving potential; an output switch unit configured to directly connect the plurality of output buffer pairs to a plurality of output line pairs or cross and connect the plurality of output buffer pairs to the plurality of output line pairs; and a charge sharing switch unit configured to connect first output lines corresponding to the first output buffers, and connect second output lines corresponding to the second output buffers.

### BRIEF DESCRIPTION OF THE DRAWINGS

FIG. 1 is a waveform diagram illustrating outputs of a conventional display driving circuit.

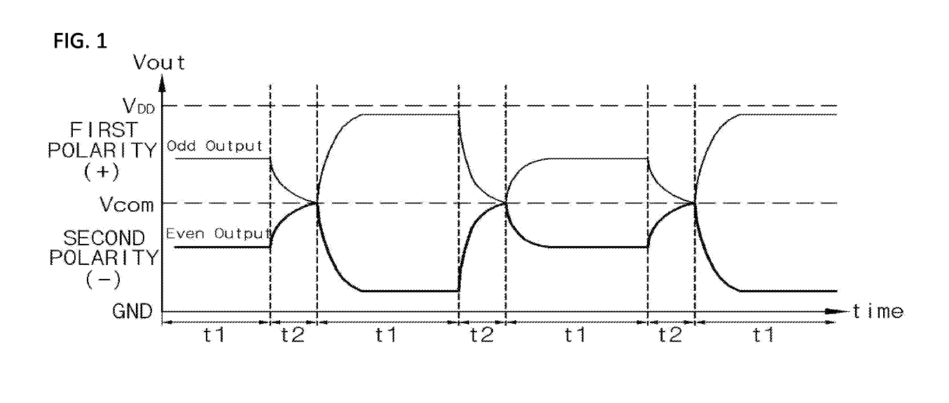

FIG. 2 is a diagram illustrating a display driving circuit in accordance with an embodiment of the present invention.

FIG. 3 is a waveform diagram illustrating output voltages of the display driving circuit of FIG. 2.

FIG. 4 is a diagram illustrating a display driving circuit in accordance with another embodiment of the present invention.

FIG. 5 is a waveform diagram illustrating output voltages of the display driving circuit of FIG. 4.

FIG. 6 is a graph illustrating power consumption simulation results of the conventional display driving circuit and the embodiment of FIG. 2.

FIG. 7 is a graph illustrating heat generation simulation results of the conventional display driving circuit and the embodiment of FIG. 2.

### DETAILED DESCRIPTION

Exemplary embodiments of the present invention are only examples for the structural or functional descriptions of the present invention. Thus, claims must not be limited by the embodiments of the present invention.

The meanings of terms used in the embodiments of the present invention should be understood as follows.

The terms “first” and “second” are used to distinguish one element from another element.

When an element is being referred to as being “connected” to another element, it should be understood that the former element can be directly connected to the latter element, but another element can exist therebetween. On the other hand, when an element is referred to as being “directly connected” to another element, it should be understood that no elements exist therebetween. Other expressions for describing the relation between elements, for example, “between” and “immediately between” or “adjacent to” and “directly adjacent to” should be analyzed in the same manner.

The terms of a singular form may include plural forms unless referred to the contrary, and the term “include” or “have” specifies the existence of a property, a number, a step, an operation, a component, a part, or a combination thereof, and does not exclude one or more other properties, numbers, steps, operations, components, or combinations thereof.

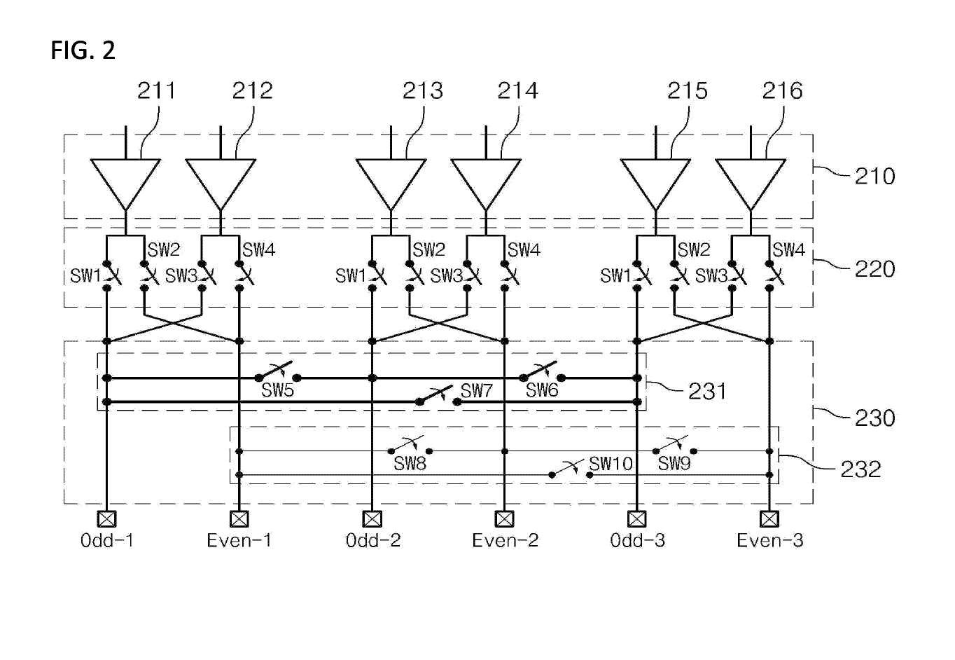

FIG. 2 is a diagram illustrating a display driving circuit 200 in accordance with an embodiment of the present invention.

Referring to FIG. 2, the display driving circuit 200, which generates a pixel driving signal and transmits the generated signal to a display panel (not illustrated), includes an output buffer unit 210, an output switch unit 220, and a charge sharing switch unit 230. The pixel driving signal may be defined as an output voltage.

The output buffer unit 210 may include three output buffer pairs (211, 212), (213, 214), and (215, 216) which buffer output voltages. Representatively, the output buffer pair 211 and 212 includes a first output buffer 211 having a first voltage driving potential and a second output buffer 212 having a second voltage driving potential. The first and second output buffers 211 and 212 may be referred to as positive (+) and negative (−) buffers, respectively. The first output buffer 211 may have a higher voltage driving potential than the second output buffer 212.

In an embodiment, the first and second voltage driving potentials may be symmetrically formed around a specific voltage. For example, when the specific voltage is 5V and supply voltages VDD and GND inputted to the first and second output buffers 211 and 212 correspond to 10V and 0V, respectively, the first voltage driving potential may be formed in the range of 5V to 10V, and the second voltage driving voltage may be formed in the range of 0V to 5V.

The output switch unit 220 may selectively connect the first output buffer 211 to a first output line Odd-1 corresponding to an odd column of the display or a second output line Even-1 corresponding to an even column of the display. Simultaneously, the output switch unit 220 may selectively connect the second output buffer 212 to the second output line Even-1 or the first output line Odd-1.

The output switch unit 220 may correspond to an inversion switching circuit which transmits an output of the output buffer unit 210 and prevents fixation of display liquid crystal.

The output switch unit 220 may include one or more switches which are positioned between the output buffer unit 210 and the output lines Odd-1 and Even-1, electrically connected to the output buffer unit 210 and the output lines Odd-1 and Even-1, and selectively connected to the output lines Odd-1 and Even-1 according to a control signal.

Referring to FIG. 2, the output switch unit 220 may include first to fourth switches SW1 to SW4. The first switch SW1 may be connected to the first output buffer 211 and the first output line Odd-1, the second switch SW2 may be connected to the first output buffer 211 and the second output line Even-1, the third switch SW3 may be connected to the second output buffer 212 and the first output line Odd-1, and the fourth switch SW4 may be connected to the second output buffer 212 and the second output line Even-1.

In an embodiment, the output switch unit 220 may selectively turn on the first and fourth switches SW1 and SW4 and the second and third switches SW2 and SW3 in a first panel charge/discharge period t1, and turn off the first and fourth switches SW1 and SW4 and the second and third switches SW2 and SW3 in a charge sharing period t2. When the potential polarities of the output lines Odd-1 and Even-1 are retained during a second panel charge/discharge period t1, the output switch unit 220 may directly connect the output buffer pair 211 and 212 to the output lines Odd-1 and Even-1. When the potential polarities of the output lines Odd-1 and Even-1 are changed at the second panel charging/discharge period t1, the output switch unit 220 may cross and connect the output buffer pair 211 and 212 to the output lines Odd-1 and Even-1.

In other words, the output switch unit 220 may be operated according to a control signal (not illustrated) outputted from a timing controller (T-CON). More specifically, the operation of the output switch unit 220 according to the control signal may be divided into three types of operations.

First, when the output switch unit 220 corresponds to a period in which valid data are transmitted or a charge/discharge period of the display panel (hereafter, referred to as panel charging/discharge period t1), the output switch unit 220 may receive a first control signal from the timing controller (not illustrated), and turn on the first switch SW1 to connect the first output buffer 211 and the first output line Odd-1 such that the valid data can be transmitted to the corresponding pixel through the first output line Odd-1. Simultaneously, the output switch unit 220 may turn on the fourth switch SW4 to connect the second output buffer 212 and the second output line Even-1.

Second, when the output switch unit 220 corresponds to the inversion period as well as the panel charging/discharge period t1, the output switch unit 220 may receive a second control signal from the timing controller, turn on the second switch SW2 to connect the first output buffer 211 and the second output line Even-1, and turn on the third switch SW3 to connect the second output buffer 212 and the first output line Odd-1. The second control signal may include a signal obtained by inverting the polarity of the first control signal.

Third, when the output switch unit 220 corresponds to the charge sharing period t2, the output switch unit 220 may receive a third control signal, and turn off all of the first to fourth switches SW1 to SW4 to block data flows to the output lines Odd-1 and Even-1.

The charge sharing switch unit 230 may connect the first output buffers 211, 213, and 215 and the second output buffers 212, 214, and 216 to the first output lines Odd-1 to Odd-3 and the second output lines Even-1 to Even-3, respectively.

The charge sharing switch unit 230 may include first and second charge sharing switching circuit 231 and 232. The first charge sharing switching circuit 231 may connect or disconnect the first output buffers 211, 213, and 215 to or from the corresponding first output lines Odd-1 to Odd-3, and the second charge sharing switching circuit 232 may connect or disconnect the second output buffers 212, 214, and 216 to or from the corresponding second output lines Even-1 to Even-3.

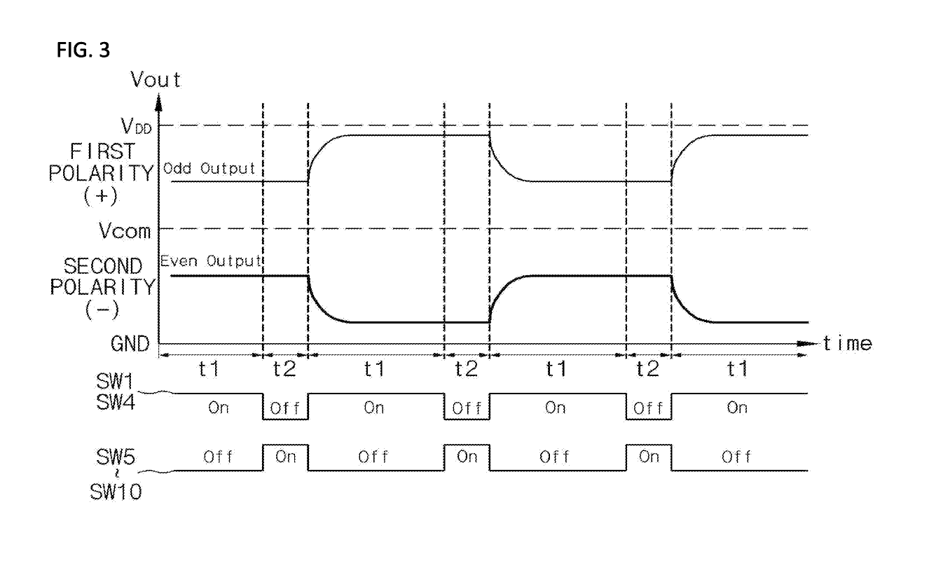

Referring to FIG. 3, the first charge sharing switching circuit 231 may connect only the odd output lines Odd-1 to Odd-3, and the second charge sharing switching circuit 232 may connect only the even output lines Even-1 to Even-3.

In an embodiment, when the first and second charge sharing switching circuits 231 and 232 are turned on, a plurality of charge sharing closed loops independent of each other can be formed in the output lines.

More specifically, the charge sharing switch unit 230 may include one or more switches which are positioned between output lines participating in charge sharing and connect the respective output lines and a switch which connects the first and last output lines participating in charge sharing.

When the display driving circuit 200 does not include the switch which connects the first and last output lines, the equivalent resistance between output lines adjacent to a specific output line may have a larger value than when the display driving circuit 200 includes the switch, even though charge sharing can be achieved. As a result, the amount of shared charge may be reduced.

The display driving circuit 200 can control the equivalent resistance between output lines adjacent to a specific output line such that the equivalent resistance has the same value. Thus, charge sharing can be uniformly performed on the output lines adjacent to the specific output line.

Referring to FIG. 2, the first charge sharing switching circuit 231 may include switches SW5 and SW6 formed among the first output lines Odd-1 to Odd-3, and a switch SW7 directly connecting the first output line Odd-1 and the last output line Odd-3.

More specifically, the first switch SW5 may be positioned between the first and second output lines Odd-1 and Odd-2, the second switch SW6 may be positioned between the second and third output lines Odd-2 and Odd-3, and the third switch SW7 may be positioned between the third and first output lines Odd-3 and Odd-1, in order to connect or disconnect the output lines to or from each other. Similarly, the even output lines Even-1 to Even-3 may also be connected or disconnected by the switches SW8 to SW10.

At this time, the line through which the first and second output lines Odd-1 and Odd-2 are directly connected and the bypass line (Odd-1->Odd-3>Odd->2) may be connected in parallel to each other, and the value of the equivalent resistance between the first and second output lines Odd-1 and Odd-2 may be smaller than the equivalent resistance when the path through the first and second output lines Odd-1 and Odd-2 are directly connected exists.

In an embodiment, each of the charge sharing closed loops may include a single closed loop or a plurality of closed sub loops.

In other words, the charge sharing switch unit 230 may connect all of the first output lines Odd-1 to Odd-3 or variably set the number of output lines participating in charge sharing.

For example, when the pixel number of the display column corresponds to 1,024, the number of first output lines (for example, Odd-1 to Odd-n) may correspond to 512, and the first charge sharing switching circuit 231 may control all of the 512 first output lines Odd-1 to Odd-n to participate in charge sharing. On the other hand, the first charge sharing switching circuit 231 may set a part of the output lines (for example, six output lines Odd-1 to Odd-6 or 12 output lines Odd-1 to Odd-12) to one charge sharing group, such that only the output lines Odd-1 to Odd-6 or Odd-1 to Odd-12 within the corresponding group share electrical charges with each other.

Since valid data of adjacent pixels may have a similar value, the configuration in which only a specific number of output lines share electrical charges with each other can reduce power consumption, compared to the configuration in which the entire output lines share electrical charges with each other.

The charge sharing switch unit 230 may connect the first output lines Odd-1 to Odd-3 and connect the second output lines Even-1 to Even-3 in a specific output period of the output lines.

More specifically, the charge sharing switch unit 230 may connect the first output lines Odd-1 to Odd-3 and connect the second output lines Even-1 to Even-3 in the charge sharing period t2. Furthermore, the charge sharing switch unit 230 may disconnect the first output lines Odd-1 to Odd-3 and disconnect the second output lines Even-1 to Even-3 in the panel charging/discharge period t1.

The first output lines Odd-1 to Odd-3 may share electrical charges with each other according to the operation of the first charge sharing switching circuit 231, and the second output lines Even-1 to Even-3 may share electrical charges with each other according to the operation of the second charge sharing switching circuit 232, thereby reducing power consumption of the display driving circuit 200.

During the charge sharing period t2, the switches SW5 to SW10 in the charge sharing switch unit 230 may be turned on to connect the respective output lines, electrical discharges from the display panel may be supplied to the charge sharing switch unit 230, and the respective output lines may share electrical charges to retain the same voltage.

On the other hand, during the panel charge/discharge period t1, the switches SW5 to SW10 within the charge sharing switch unit 230 may be turned off, and the charge sharing between the output lines may be ended to prohibit charge transfer or distribution between the output lines, and image driving signals may be supplied to the output lines through the output buffer unit 210.

In the present embodiments, three output buffer pairs have been taken as an example for description. However, the present invention is not limited thereto, and the number of output buffer pairs may be set to two or four or more, depending on products to which the present invention is applied.

FIG. 3 is a waveform diagram illustrating the output of the display driving circuit of FIG. 2.

Referring to FIG. 3, during the panel charge/discharge period t1, the output switch unit 220 may receive the first control signal, selectively and alternately turn on the first and fourth switches SW1 and SW4 and the second and third switches SW2 and SW3, and supply image driving signals outputted from the output buffer unit 210 to the output lines. At this time, the charge sharing switch unit 230 receiving the first control signal may be turned off.

When the panel charging/discharge period t1 changes to the charge sharing period t2, the output switch unit 220 may be turned off, and the display driving circuit 200 and the display panel (not illustrated) may be opened. At this time, the charge sharing switch unit 230 receiving the second control signal may be turned on, and the output lines may share electrical charges which exist in the display panel.

The first charge sharing switching circuit 231 may control the odd output lines Odd-1 to Odd-3 to share electrical charges with each other, and the second charge sharing switching circuit 232 may control the even output lines Even-1 to Even-3 to share electrical charges with each other.

When the voltages of the first output lines Odd-1 to Odd-3 are equal to each other, the voltages of the first output lines Odd-1 to Odd-3 may be constantly retained even though charge sharing is achieved according to the operation of the first charge sharing switching circuit 231. Similarly, the second output lines Even-1 to Even-3 may also retain a constant voltage.

On the other hand, when the voltages of the first output lines Odd-1 to Odd-3 are not equal to each other, the first output lines Odd-1 to Odd-3 may share electrical charges according to the operation of the first charge sharing switching circuit 231 and have an average voltage or an arbitrary pre-voltage level.

When the charge sharing period t2 changes to the panel charge/discharge period t1, the output switch unit 220 may selectively and alternately turn on the first and fourth switches SW1 and SW4 and the second and third switches SW2 and SW3, and supply the image driving signals outputted from the output buffer unit 210 to the output lines. Similarly, the charge sharing switch unit 230 may be turned off.

Since the display driving circuit in accordance with the embodiment of the present invention provides only power corresponding to a difference between the potential corresponding to the valid data of the first output lines Odd-1 to Odd-3 and the previous average potential of the first output lines Odd-1 to Odd-3, the power consumption can be reduced.

For example, when the potential of the valid data of the first output lines Odd-1 to Odd-3 corresponds to 7.5V in the first panel charge/discharge period t1 and 10V in the second panel charging/discharge period t1, the conventional display driving circuit must lower the potential of the first output lines Odd-1 to Odd-3 to 5V through the charge sharing period t2, and raise a potential of 5V in the second panel charge/discharge period t1. In the present embodiment, however, since the potential of the first output lines Odd-1 to Odd-3 retains 7.5V in the charge sharing period t2, the display driving circuit 200 may raise a potential of 2.5V in the second panel charge/discharge period t1. As a result, the display driving circuit 200 in accordance with the embodiment of the present invention may reduce the power consumption required for raising the potential of 2.5V, compared to the conventional display driving circuit.

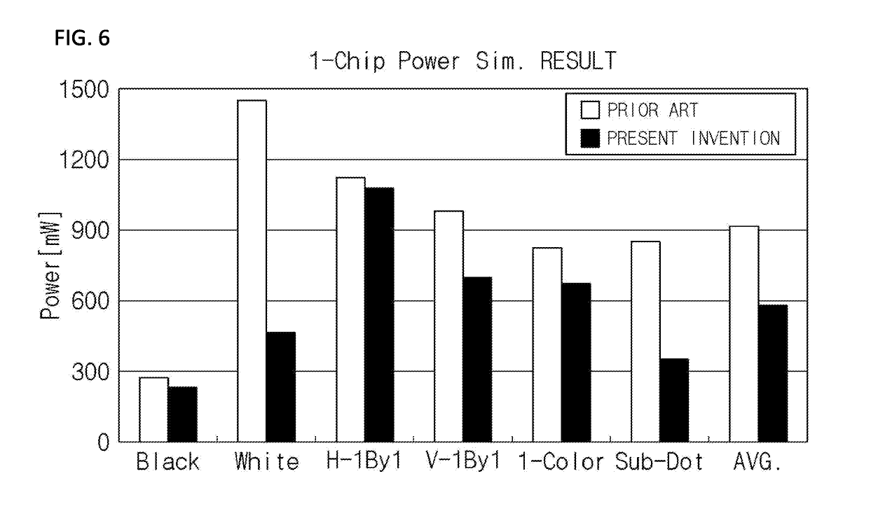

FIG. 6 is a graph illustrating power consumption simulation results in the conventional display driving circuit and the embodiment of FIG. 2.

In FIG. 6, the X axis of the graph illustrating the power consumption simulation results represents test patterns of the display, and the Y axis represents power (mW) consumed by the display driving circuits according to each of the test patterns.

More specifically, the X axis may include a black pattern which outputs a black still image, a white pattern which outputs a white still image, a horizontal line pattern H-1By1 which outputs a horizontal-striped still image by crossing block and white colors at each horizontal scanning line, a vertical line pattern V-1By1 which outputs a vertical-striped still image by crossing black and white colors at each vertical scanning line, a one-color pattern which outputs a specific color of still image, a sub dot pattern which outputs a checkered still image by exclusively driving sub pixels (red, green, and black pixels) between adjacent pixels, and a pattern average AVG which indicates the average of the patterns.

A white bar-shaped graph indicates power consumption of the conventional display driving circuit, and a black bar-shaped graph indicates power consumption of the display driving circuit 200 in accordance with the embodiment of the present invention.

In the case of the black pattern, the power consumption of the display driving circuit 200 in accordance with the embodiment of the present invention corresponds to about 220 mW which is reduced by about 50 mW (18%) from the power consumption (about 270 mW) of the conventional display driving circuit.

In the case of the white pattern which has a potential variation in output voltage based on the intermediate potential Vcom, the power consumption of the display driving circuit 200 in accordance with the embodiment of the present invention corresponds to about 450 mW which is reduced by about 1,000mW (about 70%) from the power consumption (1,450 mW) of the conventional display driving circuit.

In the other patterns, the display driving circuit 200 may have a power consumption reduction effect of 5% (H-1By1) to 60% (Sub Dot), compared to the conventional display driving circuit.

Overall, the average power consumption AVG of the display driving circuit 200 corresponds to about 600 mV which is reduced by about 300 mW (34%) from the average power consumption (about 900 mW) of the conventional display driving circuit.

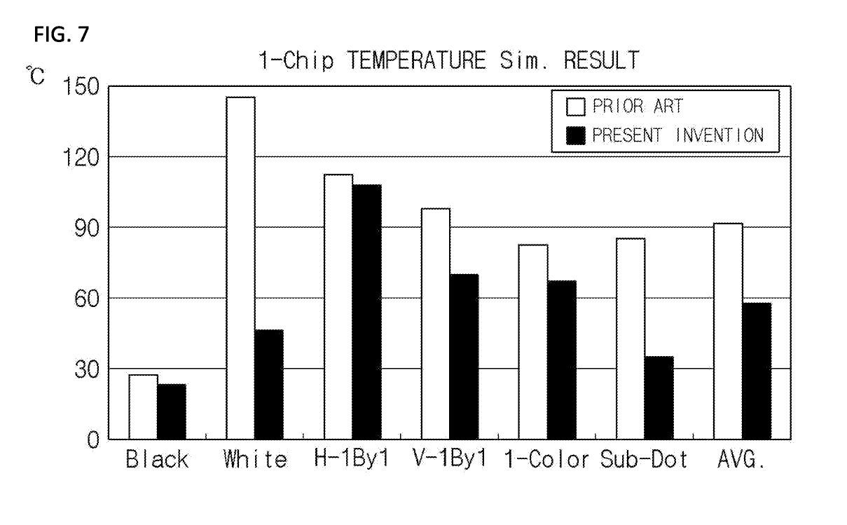

FIG. 7 is a graph illustrating heat generation simulation results of the conventional display driving circuit and the present embodiment.

In FIG. 7, the X axis of the graph illustrating the heat generation simulation results represents the test patterns of the display, and the Y axis represents temperatures measured by the display driving circuits according to each of the test patterns.

In the case of the white pattern, the temperature of the display driving circuit 200 corresponds to about 60° which is reduced by 80° (about 57%) from the temperature (140°) of the conventional display driving circuit.

In the other patterns, the display driving circuit 200 may have a temperature reduction effect of 5% (H-1By1) to 40% (Sub Dot), compared to the conventional display driving circuit.

Overall, the average temperature AVG of the display driving circuit 200 corresponds to about 70° which is reduced by about 30° (30%) from the temperature (about 100°) of the conventional display driving circuit.

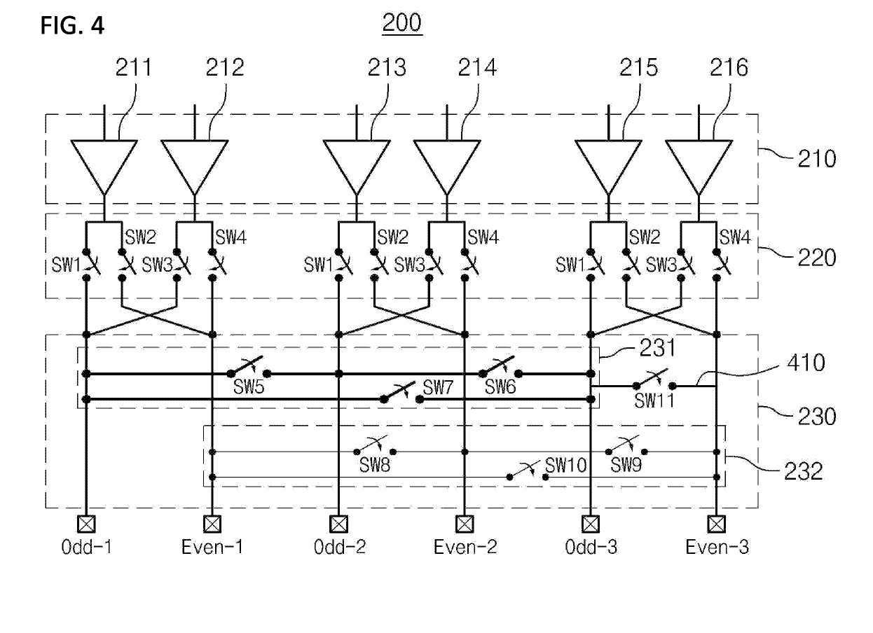

FIG. 4 is a diagram illustrating a display driving circuit 200 in accordance with another embodiment of the present invention.

Referring to FIG. 4, the display driving circuit 200 may further include one or more common switching circuits 410 or SW11 connecting the first and second output liens Odd-1 and Even-1 within the output line pairs.

The common switching circuit 410 or SW1 may be operated when the polarity of a pixel needs to be inverted according to a control signal generated by the timing controller. More specifically, the common switching circuit 410 or SW11 may be turned on in an inversion period t3, and enable charge sharing between the first and second output lines Odd-1 and Even-1. After the inversion is achieved, the common switching circuit 410 or SW11 may be turned off to control the first and second charge sharing switching circuits 231 and 232 to independently perform charge sharing.

When the polarity is inverted, the image driving signal outputted through the output buffer pair 310 may be changed after passing through a specific voltage driving potential (for example, the intermediate potential Vcom). Thus, as the image driving signal is pre-driven to the intermediate potential Vcom, the amount of current to be supplied to the buffer can be reduced.

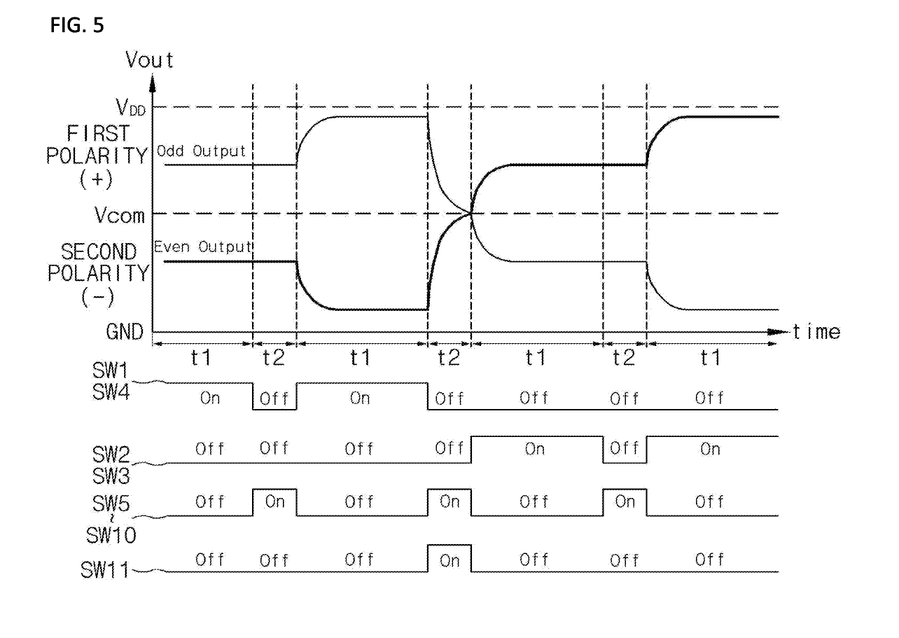

FIG. 5 is a waveform diagram illustrating the output of the display driving circuit of FIG. 4.

Referring to FIG. 5, when inversion is not needed, the common switching circuit 410 or SW11 may be turned off, and the display driving circuit 200 may be operated in the same manner as FIG. 4.

When the inversion is needed, the output switch unit 220 may be turned off according to the third control signal, and the charge sharing switch unit 230 and the common switching circuit 410 may be turned on, during the charge sharing period. Then, the first and second output lines Odd-1 and Even-1 may share electrical charges with each other. At this time, the potential of each output line may change to the average potential of the output lines, and then reduce a voltage (or current) to be supplied by the first or second output buffer 211 or 212, thereby reducing power consumption.

In accordance with the embodiments of the present invention, the display driving circuit may include the charge sharing switching circuit to reduce power consumption and heat generation.

Furthermore, the display driving circuit may efficiently perform charge sharing for the output voltage by equalizing the number of charge sharing switches to the number of output lines.

Furthermore, the display driving circuit may include the common switch circuit to reduce current consumption and heat generation when the polarity of the output voltage is inverted.

While various embodiments have been described above, it will be understood to those skilled in the art that the embodiments described are by way of example only. Accordingly, the disclosure described herein should not be limited based on the described embodiments.

What is claimed is:

1. A display driving circuit comprising:
an output buffer unit comprising a plurality of output buffer pairs, wherein among the plurality of output buffer pairs, each of first output buffers has a first voltage driving potential, and each of second output buffers has a second voltage driving potential;
an output switch unit configured to directly connect the plurality of output buffer pairs to a plurality of output line pairs, or cross and connect the plurality of output buffer pairs to the plurality of output line pairs; and
a charge sharing switch unit configured to connect first output lines corresponding to the first output buffers, and connect second output lines corresponding to the second output buffers.

2. The display driving circuit of claim 1, wherein the charge sharing switch unit comprises:
a first charge sharing switching circuit configured to connect or disconnect the first output lines among the plurality of output line pairs; and
a second charge sharing switching circuit configured to connect or disconnect the second output lines among the plurality of output line pairs.

3. The display driving circuit of claim 2, wherein the first and second charge sharing circuits form a plurality of charge sharing closed loops independent of each other in the output lines when the first and second charge sharing circuits are turned on.

4. The display driving circuit of claim 3, wherein each of the charge sharing closed loops comprises a single closed loop or a plurality of closed sub loops.

5. The display driving circuit of claim 2, wherein the first and second charge sharing switching circuits connect the first output lines and connect the second output lines in a specific output period of the plurality of output line pairs.

6. The display driving circuit of claim 5, wherein the first and second charge sharing switching circuits connect the first output lines and connect the second output lines in a charge sharing period and disconnect the first output lines and disconnect the second output lines in a panel charge/discharge period.

7. The display driving circuit of claim 6, wherein the first and second charge sharing switching circuits share electrical charges discharged in a display process when the first output lines are connected and the second output lines are connected during the charge sharing period.

8. The display driving circuit of claim 6, wherein the first and second charge sharing switching circuits prohibit distribution of electrical charges required for a display process when the first output lines are disconnected and the second output lines are disconnected at the panel charge/discharge period.

9. The display driving circuit of claim 1, wherein the charge sharing switch unit further comprises one or more common switching circuits configured to connect the first and second output lines within the output line pairs.

10. The display driving circuit of claim 9, wherein the common switching circuit is turned off in a first panel charge/discharge period and a charge sharing period, and turned on when the polarity of the voltage level of the output line is changed in a second panel charge/discharge period.

11. The display driving circuit of claim 1, wherein the first and second voltage driving potentials are symmetrically formed around a specific voltage driving potential.

12. The display driving circuit of claim 1, wherein the output switch unit directly connects the plurality of output buffer pairs to the plurality of output line pairs when the polarity of the voltage level of the output line is retained during a charge/discharge period, and crosses and connects the plurality of output buffer pairs to the plurality of output line pairs when the polarity of the voltage level of the output line is changed in the charge/discharge period.

13. A display device which includes a display panel and a display driving circuit for driving the display panel,
wherein the display driving circuit comprises:
a plurality of output buffer units each comprising a plurality of output buffer pairs, wherein among the plurality of output buffer pairs, each of first output buffers has a first voltage driving potential, and each of second output buffers has a second voltage driving potential;
an output switch unit configured to directly connect the plurality of output buffer pairs to a plurality of output line pairs, or cross and connect the plurality of output buffer pairs to the plurality of output line pairs; and
a charge sharing switch unit configured to connect first output lines corresponding to the first output buffers, and connect second output lines corresponding to the second output buffers.
